(19) United States
(12) Patent Application Publication
(10) Pub. No.: US 2007/0062936 A1
(43) Pub. Date: Mar. 22, 2007

(54) Microwave susceptors incorporating expandable polymeric particles

(76) Inventors: James C. Young, Newark, DE (US); Wayne Marsh, Bear, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/511,775

(22) Filed: Aug. 29, 2006

Related U.S. Application Data
(60) Provisional application No. 60/712,224, filed on Aug. 29, 2005.
(60) Provisional application No. 60/712,221, filed on Aug. 29, 2005.
(60) Provisional application No. 60/712,218, filed on Aug. 29, 2005.

(51) Int. Cl. H05B 6/80

(52) U.S. Cl. 219/730

(57) ABSTRACT

The present invention relates to the field of microwave heating, in particular to the use of so-called microwave susceptors for providing localized thermal heating for the purpose of heating an object, such as the browning or crisping a food item. Most particularly, the present invention relates to a technology for providing heating while avoiding overheating. The present invention provides a microwave susceptor comprising a substrate, a microwave-interactive component, and a plurality of expandable semicrystalline thermoplastic polymeric microspheres in thermally conductive contact with the microwave-interactive component. In a preferred embodiment, the expandable microspheres are disposed in such manner that upon reaching a pre-determined temperature the heating rate of the composite microwave susceptor is reduced.

This application claims the benefit of U.S. Provisional Applications 60/712,224, 60/712,218 and 60/712,221; each of which was filed 29 Aug. 2005, and is incorporated in its entirety as a part hereof for all purposes.

### TECHNICAL FIELD

The present invention relates to the field of microwave heating, and in particular to the use of so-called microwave susceptors for providing localized thermal heating. Most particularly, the present invention relates to a technology for providing thermal heating while avoiding overheating. The inventions provided herein are useful, for example, for the purpose of heating a human food item, and in particular for browning or crisping a food item without burning it.

### BACKGROUND

A microwave susceptor, as used in both consumer and industrial applications, is a material that absorbs microwave energy, converts the absorbed energy to heat energy, and thereby heats surrounding media. As typically used, a microwave susceptor may be formed as a thin film where a layer of a dielectric film, typically made from poly(ethylene terephthalate) (“PET”), is aluminized. Often this aluminized film is laminated to other layers of plastic film or cellulosic paper, thereby forming, for example, a layered structure or multilayer laminate. When it is desired to use a microwave susceptor to heat a food item, the food item is typically disposed in heatable proximity to the susceptor such that, upon microwave irradiation, the food item will be heated by both direct absorption of microwave radiation and by conduction and/or convection heating from the susceptor. Microwave susceptors are often employed when it is desired to impart a browned and/or crisped surface to a food item during microwave heating.

U.S. Pat. No. 4,970,358 describes a susceptor containing carbon particles as a microwave interactive element, mixed with non-microwave-interactive mineral hydrate particles that act as temperature moderators. U.S. Pat. No. 5,349,168 describes a composition with a dielectric substrate having a portion of its surfaces coated with a matrix composition containing susceptor particles and another portion with blocking agents. U.S. Pat. No. 5,412,187 describes a self-limiting metallized film susceptor with metal layers patterned in such a way as to form “fuse” like structures that short out when too much MW energy (heat) is absorbed locally.

The degree of browning and crisping of human food items, such as raw, uncooked pizza dough, that can currently be achieved is limited by the temperature limitations of the microwave oven systems in common commercial use. It is desired to expand the range of browning and crisping capabilities of microwave susceptors by developing microwave susceptors that are capable of operating at higher temperatures. Many putative solutions to the problem exhibit a tendency to impart excessive heat to a food item, resulting in run-away heating, charring, or even burning, rather than browning. In some instances, an entire microwaveable package will ignite. The technological challenge is not to simply expose the food item to a higher temperature, but to control the temperature so that the food item will properly brown and crisp without charring.

In addition, the metallized films in common commercial use are not well suited to patterning to provide selective heating. Efforts have been underway for many years to develop new microwave susceptor materials that could be positioned on a package with the accuracy of printing.

### SUMMARY

In one embodiment, this invention provides a microwave susceptor that includes a substrate, a microwave-interactive component that is supported by the substrate, and a plurality of expandable semicrystalline thermoplastic polymeric microspheres that are in thermally-conductive contact with the microwave-interactive component.

In another embodiment of this microwave susceptor, the microwave-interactive component may be a film, or a conductive particulate material dispersed in a binder. Expandable semicrystalline thermoplastic polymeric microspheres may also be dispersed in the binder.

In yet another embodiment of this microwave susceptor there may be (a) a first layer, disposed on the substrate, that includes expandable semicrystalline thermoplastic polymeric microspheres and a binder; and (b) a second layer, disposed on the first layer, that includes a microwave-interactive film or microwave-interactive particulates; wherein the first layer is in thermally conductive contact with the second layer. In a further embodiment, the positions of the layers may be reversed, and a microwave-interactive film or microwave-interactive particulates may be disposed on the substrate.

In a further embodiment, the microwave susceptor provided by-this invention may be a layer in a layered structure, and the layered structure may be used to protect human food from contamination. Alternatively, the microwave susceptor provided by this invention may be enclosed in or contacted with a package that protects human food from contamination.

In a further embodiment, this invention provides a method of making a microwave susceptor by
(a) providing a substrate, supporting a microwave-interactive component on the substrate, and disposing expandable semicrystalline thermoplastic polymeric microspheres in thermally-conductive contact with the microwave-interactive component;
(b) providing a substrate, depositing expandable semicrystalline thermoplastic polymeric microspheres on the substrate, and disposing a microwave-interactive component on the microspheres; or
(c) (i) admixing expandable semicrystalline thermoplastic polymeric microspheres, microwave interactive particulates, and a binder; and (ii) applying the mixture to a substrate.
   A susceptor having been thus made, may then be fabricated as, or may be contacted with, a package that protects human food from contamination.

In yet another embodiment, this invention provides a method of heating an object by placing the object is heatable proximity to a microwave susceptor as described above, and subjecting the object and the microwave susceptor to microwave radiation.

### BRIEF DESCRIPTION OF THE DRAWINGS

FIG. 1 depicts a physical layout of a microwave susceptor of the invention.

FIG. 2 depicts a further embodiment wherein a food item is disposed on the substrate side of a microwave susceptor of the invention.

FIG. 3 depicts schematically the apparatus employed for measuring the temperature of microwave susceptors during exposure to microwave radiation.

FIG. 4 is a graph of temperature versus time of exposure for Examples 1-2 and Comparative Example 1.

FIG. 5 is a graph of temperature versus time of exposure for Examples 3-5 and Comparative Example 2.

FIG. 6 is a graph of temperature versus time of exposure for Examples 6-8.

FIG. 7 shows the results of cooking pizza according to the invention.

### DETAILED DESCRIPTION

According to this invention, there is provided a microwave susceptor that includes a substrate, a microwave-interactive component that is supported by the substrate, and a plurality of expandable semicrystalline thermoplastic polymeric microspheres that are in thermally-conductive contact with the microwave-interactive component.

The microspheres used in the microwave susceptor of this invention are hollow, heat-expandable, semicrystalline thermoplastic polymeric spheres containing a thermally-activatable expanding agent. More particularly, these heat expandable microspheres are small hollow spherical plastic particles consisting of a polymer shell encapsulating a gas. When the gas inside the shell is heated, it increases its pressure and the semi-crystalline thermoplastic shell softens, resulting in a dramatic increase in the volume of the microspheres. Microspheres suitable for use for such purpose are described in U.S. Pat. No. 3,615,972 (“Morehouse”), which is incorporated in its entirety as a part hereof for all purposes.

These microspheres may be made in an aqueous system by a limited coalescence process under pressure, the resulting product of which is a “wet cake” of the unexpanded microsphere beads, wetting agents and water, which may or may not require drying prior to further use. In the limited coalescence technique, the following general procedure may be utilized:
1. A polymerizable liquid containing a volatilizable compound is dispersed within an aqueous nonsolvent liquid medium to form a dispersion of droplets having sizes not larger than the size desired for the polymer globules, whereupon
2. the dispersion is allowed to rest and to reside with only mild or no agitation for a time during which a limited coalescence of the dispersed droplets takes place with the formation of a lesser number of larger droplets, such coalescence being limited due to the composition of a suspending medium, the size of the dispersed droplets thereby becoming substantially uniform and of a desired magnitude, and
3. the uniform droplet dispersion is then stabilized by addition of thickening agents to the aqueous suspending medium, whereby the uniform-sized dispersed droplets are further protected against coalescence and are also retarded from concentrating in the dispersion due to a difference in density of the dispersed phase and continuous phase, and
4. the polymerizable liquid or oil phase in such stabilized dispersion is subjected to polymerization conditions and polymerized, whereby globules of polymer are obtained having spheroidal shape and substantially uniform and desired size, which size is predetermined principally by the composition of the initial aqueous liquid suspending medium.
   Methods for drying a wet-cake are disclosed in U.S. Pat. No. 5,180,752 (“Melber”), which is incorporated in its entirety as a part hereof for all purposes.

The diameter of the droplets of polymerizable liquid, and hence the diameter of the beads of polymer, can be varied predictably by deliberate variation of the composition of the aqueous liquid dispersion within the range of from about 0.5 to about 5000 micrometers. For any specific operation, the range of diameters of the droplets of liquid, and hence of the resulting polymeric microspheres, has a factor in the order of three or less. Microsphere size is determined principally by the composition of the aqueous dispersion. Mechanical conditions, such as the degree of agitation, the size and design of the apparatus used, and the scale of operation, are not highly critical. Other methods of preparation of microspheres suitable for use herein, such as suspension polymerization, may also be employed, but are less preferred because particle diameter is less well-controlled and is more sensitive to agitation conditions.

Microspheres suitable for use herein may be prepared from a wide variety of semicrystalline thermoplastic polymers including copolymers prepared from acrylate monomers such as acrylonitrile, methyl methacrylate, ethyl acrylate, propyl acrylate, butyl acrylate, butyl methacrylate, propyl methacrylate, lauryl acrylate, 2-ethylhexylacrylate, ethyl methacrylate, and the like. Also suitable are copolymers of vinyl chloride and vinylidene chloride, copolymers of acrylonitrile with vinyl chloride, vinyl bromide. Also suitable are poly(vinyl esters) such as poly(vinyl acetate), poly(vinyl butyrate), poly(vinyl stearate), poly(vinyl laurate), poly(vinyl myristate), poly(vinyl propionate), and the like. The selection of the particular semi-crystalline thermoplastic polymer will depend upon the requirements of the particular application of the invention hereof. These requirements will include chemical compatibility with the environment in which it will be employed, and the temperature range in which it is desired to practice the invention hereof. For example, it may be desirable to select as the polymer from which the shell is prepared a polymer that has a melting point above the desired maximum temperature of operation of the susceptor, while the glass transition temperature of the shell polymer is below the desired maximum temperature. Preferably the melting point will be at least 20° C. above the desired maximum temperature, and the glass transition temperature will be at least 20 C° below the desired maximum temperature.

A microsphere as used herein contains a volatilizable compound, which may be any thermally activated volatilizable substance that is susceptible to being encapsulated by the hollow semicrystalline thermoplastic polymeric microsphere, and that, upon heating to a temperature below the melting point of the microsphere, undergoes volatilization to a sufficient degree that the sphere expands to a volume at least ten times that of the size of the unexpanded microsphere. The volatilizable compound will need to be inert to the polymer of the microsphere, and have little or no solubility therewith. Additionally, the volatilizable compound may be selected to be volatilized at a temperature in the range of about 0 to 10° C. above the target maximum temperature of operation of the microwave susceptor hereof. In certain embodiments, for example, the microspheres may start to expand anywhere between about 100 and about 200° C.

A wide variety of volatilizable compounds can be employed for this purpose, including the C₃-C₈ alkanes, particularly propane, butane, pentane, and mixtures thereof, which are well-suited to use with poly(vinylidene chloride). The selection of the volatilizable compound is a function of the particular semicrystalline thermoplastic polymer employed and the temperature at which expansion is desired to occur. For example, isobutane is most often used with polyvinylidene chloride microspheres.

Glass transition temperatures, and softening melting points, of semicrystalline thermoplastic polymers useful for preparing a expandable microsphere herein are well known, and these may be matched with equally well known vapor pressure data of numerous liquids useful as a volatilizable compound in a microsphere, to design an expandable microsphere with a temperature range suitable for a particular susceptor application.

The microspheres used in the microwave susceptor of this invention are particles that typically are substantially spherical in shape but that need not be perfectly spherical as variations in shape are possible. Microspheres suitable for use herein, when in the characteristic spherical shape, will typically have a centrally located cavity containing the volatilizable compound. In preferred embodiments hereof, use may be made of expandable microspheres having diameters ranging from 10 to 100 micrometers before expansion, preferably 20-40 micrometers before expansion. Microspheres having a diameter smaller than 10 microns before expansion may be less preferred as they may expand only to a size at which they function less effectively as a susceptor component than if they were larger, and, correspondingly, microspheres having a diameter larger than 100 micrometers before expansion may be less preferred due to difficulties of handling in the fabrication of the susceptor.

Size of particles may be determined by average equivalent spherical diameter or by other suitable means. The term “micro-scale” as used herein concerning particle size refers to particles characterized by an average equivalent spherical diameter of greater than 1 to about 100 micrometers, preferably from about 20 to about 40 micrometers. The term “nano-scale” as used herein concerning particle size correspondingly refers to particles characterized by an average equivalent spherical diameter of about 1 to about 1000 nanometers. The term “average equivalent spherical diameter” refers to a volume-sensitive method for determining a particle size distribution in which the volume distribution of particles is determined and the diameter of spheres exhibiting an equivalent volume distribution is computed. The average equivalent spherical diameter is then the average diameter of the population of spheres having the same volume distribution.

While average equivalent spherical diameter is the principal characteristic of the particle size distribution, such determination does not take into consideration other aspects of particle morphology such as aspect ratio, aspects of particle size distribution such as the width of the distribution, or any deviations from a gaussian distribution. For example, particle populations having particularly numerous large particles are less preferred.

Average equivalent spherical diameter, which is used to specify the average (median) size of a non-spherical particle in terms of the diameter of a sphere of the same material that would have the same mass as the particle in question, may also be calculated based on the sedimentation rate of the particle in questions as defined by Stokes' Law, Micromeritics SediGraph 5100 Particle Size Analysis System Operator's Manual, V2.03, 1990. Specific surface area refers to the area of the surface of a particle per unit weight based on the quantity of nitrogen gas that absorbs as a single layer of gas molecules on the particle. Once the gas adsorption properties of the material in question have been measured, then the surface area of the material in question is calculated using the Brunauer-Emmett-Teller equation, Micromentics Flowsorb II 2300 Instruction Manual, 1986. Equivalent spherical diameter of particles may also be measured by automated sedimentation equipment such as the Micromeritic SediGraph 5000 E particle size analyzer. This device uses low energy X-rays to determine the concentration of particles at various depths in a column of known fluid. The laws of hydrodynamics require that the settling rate of a particle in a fluid is related to the mass of the particle. The SediGraph determines the population of particles of a particular mass in the powder grade by measuring the density of particles at given levels within the fluid. Since the diameter of an ideal spherical particle is related to its mass by means of its density and volume (i.e. diameter), each density measurement in the SediGraph corresponds to a population count of particles with a mass that is equivalent to that of a spherical particle having a diameter, d (designated ESD). Therefore, particles are completely characterized by the population size distribution measured by the sedimentation technique and the average ESD corresponding to the median value in that distribution.

Alternatively, the tern “micro-scale” may refer to the size of a particle in which the longest dimension of the largest cross section of the particle is in the range of greater than 1 to about 100 micrometers; and, correspondingly, “nano-scale” may alternatively be defined with respect to a longest cross-sectional dimension in the range of about 1 to about 1000 nanometers.

Dry, unexpanded microspheres typically have a density of about 1.1 g/cm³. Upon expansion, they are typically enlarged in diameter by a factor of at least about 5 to 10 times the diameter of the unexpanded beads, giving rise to a density, when dry, of about 0.1 g/cm³ or less, frequently about 0.03 to 0.06 g/cm³, and even as low as about 0.015 to 0.020 g/cm³. Expanded microspheres may have a “surface barrier coating” fabricated from a material such as talc, calcium carbonate, barium sulfate, alumina (particularly alumina tri-hydrate), silica, titanium dioxide or zinc oxide. Such a surface barrier coating will frequently be in the range of about 20 to about 97 weight percent of the total combined weight of the barrier coating material and the microsphere material, on a dry weight basis. It is generally preferred that the barrier coating material be employed in amounts less than about 90, and preferably less than 80, weight percent of the combined total weight.

Expandable microspheres that are comparable to those described above, and/or that are obtainable from the above cited references, are also available commercially as Micropearl™ microspheres or Dualite® microspheres from Pierce and Stevens division of Sovereign Specialty Chemicals (Buffalo, N.Y.), and as certain grades of Expancel™ microspheres (such as an Expancel™ 98DU120 microsphere) from Akzo Nobel Corporation. These microspheres are typically expandable, hollow microspheres having a thin shell of a polymer such as poly(vinyl chloride), poly(vinylidene chloride), polypropylene, polyacrylonitrile, an acrylonitrile copolymer, a poly(alkyl methacrylate) or polystyrene. Contained within the interior of the microsphere is a volatile substance—a “volatilizable compound”—which is thermally-activated and serves to expand the sphere as much as 40-fold, such as 10 to 40 times, by volume. The Micropearl™ microspheres, for example, contain pentane as a volatilizable compound within the interior, while isobutane is contained within the Expancel™ microspheres. Other organic or inorganic material that vaporizes upon heating will also serve to expand a microsphere, with any decomposition products remaining in the shell thereafter.

The substrate, for use in conjunction with the microwave-interactive component and the expandable microspheres to form a microwave susceptor of this invention, can be any ink-receptive material such as is known in the art of printing, including polymeric films, both semicrystalline thermoplastic and thermoset, microwave transparent plastic sheet materials, paper or paperboard, woven or non-woven fabrics, or a multilayered laminated structure having a dielectric backing substrate that is transparent to microwave energy. Suitable polymeric films include polyesters, polyetherketones, polyimides, polyolefins and copolymers thereof, polyvinylaromatics, polycarbonates, acrylate polymers, and the like; and to a somewhat lesser extent polyamides and polyolefins and copolymers thereof. Suitable paper and paperboard includes cellulosic paper, and papers formed from fibrils of poly(m-phenyleneisophthalamide), poly(p-phenyleneterephthalamide), and mixtures thereof. The substrate can, for example, be 15 to 50-pound grease proof kraft paper. A substrate will typically be about 25 to about 50 micrometers thick, and substrate materials are preferably stable up to about 250°-300° C.

In one embodiment, the microspheres may be deposited directly on the substrate together with a binder. The binder provides a matrix to hold the heat expandable microspheres together and to the substrate. The binder may be an acrylic polymer, or a soluble protein, however water soluble binders are preferred. The heat-expandable microspheres are uniformly dispersed with the binder in a dispersion that forms a coating or layer, such as a coated layer, on the substrate. This coating or layer is usually 1 to 3 mils (25 to 75 micrometers) in thickness, and has a content of 10 to 50 weight percent of heat-expandable microspheres by weight of the microspheres and binder together.

A microwave interactive component may then disposed on the microspheres, and the microspheres are thus in thermally-conductive contact with the microwave interactive component. A component is microwave-interactive when it is prepared from a material that is electrically conductive, and/or when it experiences heating when subjected to microwave irradiation by converting absorbed microwave energy to heat. The microspheres are in thermally-conductive contact with the microwave interactive component when the heat generated by microwave irradiation of the microwave interactive component may be transferred to the microspheres, but this need not necessarily require direct physical contact. In an alternative embodiment, however, the microwave-interactive component is disposed in direct contact with the substrate, and the microspheres are then deposited on the microwave-interactive component.

The microwave interactive component may be fabricated from electrically conductive and semi-conductive materials such as metals, metal-containing compounds and carbon black. Such materials may include for example an aluminized PET sheet or a carbon-printed paper, but metallic or metal-coated particles dispersed in a suitable carrier vehicle are useful as well. Such particles may contain materials such as carbon black, graphite, copper, nickel or zinc, as well as materials such as carbon-coated iron or carbon-coated aluminum having a thickness in the range of from about a few nanometers to about a few micrometers. Mixtures of two or more of such materials are also satisfactory.

In this invention, it is preferred to fabricate a susceptor by painting, spraying, printing or otherwise depositing the microspheres on the surface where they are desired, such as is done with a printable ink. An ink-type preparation suitable for use herein for such purpose may be formulated as a liquid or paste in any conventional manner, such as when the microspheres instead of pigment are dispersed in the binder, wherein the binder is considered in the ink-type preparation to be a “carrier vehicle” since it will either dry or cure when the ink-type preparation is applied to a surface. Other additives, such as surfactants, stabilizers, diluents, thickeners, biocides, and the like, as are commonly employed in formulating printing inks, may also be included in an ink-type preparation as used herein when desired, but these will not play any role in the heating or temperature control functions of the microwave susceptor of the invention. Suitable methods for depositing an ink-type preparation include screen printing, gravure coating and draw-down bar coating. To obtain good thickness uniformity in depositing an ink-type preparation, it is desirable to deposit several thin layers to the desired thickness rather than in one layer. Methods similar to those used, for example, to obtain three-dimensional patterns on wallpaper or textiles may also be desirable.

In addition to the materials mentioned elsewhere herein for use as a binder, suitable carrier vehicles for use herein in an ink-type preparation include water-based systems incorporating high-acid acrylic or protein resins dissolved in ammoniacal water along with small amounts of low alcohols or glycol ethers, as well as fluid organic and resinous film formers that serve as a base or matrix to hold the ink-type preparation together and to the underlying surface. The ink-type preparation may thus contain a carrier vehicle such as an acrylic, protein, shellac or maleic polymer, although the solvent can be water or a variety of so-called spirit based vehicles, with water-based systems being preferred. The solvent will be one that can be conveniently dried at elevated temperature but well-below the expansion temperature of the expandable microspheres.

The microwave-interactive component may also be applied as a coating irrespective of whether it is applied to the substrate or to the microspheres, although applying it as a solid pre-formed sheet or layer in either instance is satisfactory as well. When the interactive component is applied as a fluid to form a coating, a useful material for that purpose is a carbon black dispersion as described in US 2005 0,142,255. The carbon black is neutralized with ammonia to pH 8-9, and milled in the presence of polysorbate-80. An ink-type preparation formed therefrom by neutralizing soy protein in the carbon black dispersion, and mixing at high speed (using a Cowles blade) for 1 hour. Plasticizer (glycerin) and biocide are then added, and mixed in at low speed for 15 minutes.

In another embodiment, the microwave-interactive component may be applied as an ink-type preparation formed by combining 5 to 20 parts by weight natural polymer binder, 7 to 20 parts by weight of a substantially non-aggregated particulate nonmetallic nano-scale microwave-interactive material, 50 to 88 parts by weight of water, and, optionally, up to 10 parts by weight of a chemical dispersing aid for the microwave-interactive material, wherein the binder, microwave-interactive material, water and chemical dispersing aid total 100 parts by weight.

A natural polymer is typically a polymeric material that occurs in nature, and is preferably obtained from a plant source. A natural polymer suitable-for use as the binder in this invention is preferably water-soluble, and is more preferably a material having FDA or equivalent governmental clearance for contact with human food. Suitable natural polymers for use as binders include proteins or derivatives thereof; corn starch; polysaccharides or derivatives thereof; and cellulosic materials. Preferred natural polymer binders are water-soluble, can be used as a food additive, and are thermally stable up to about 200° C. in air. The most preferred natural polymer for use as a binder is a soy protein or a derivative thereof.

When the microwave-interactive component is a separate sheet or layer, it may, for example, be fabricated as free-standing film by film casting, molding, profile extrusion, pultrusion and the like. Lamination of layers may be performed by any convenient means such as thermal calendaring or adhesive bonding.

In a further alternative embodiment hereof, the expandable microspheres may be mixed into a carbon ink-type formulation, and the resulting formulation is applied to the substrate to form a composite microwave susceptor. In this embodiment, the expandable microspheres and the microwave-interactive component are applied to the substrate together and form a single layer on the substrate. For the purposes of the present invention, the single layer so formed may be applied in a single pass or multiple passes, and may be formulated with microwave-interactive materials other than carbon. In other embodiments, however, multiple layers, varying in composition, but all containing both microspheres and a microwave-interactive are applied to a substrate to provide another version of a composite susceptor.

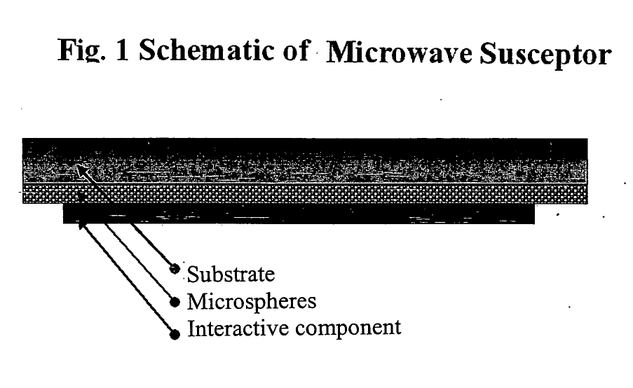

In a preferred embodiment of the microwave susceptor of this invention, as shown in FIG. 1, microspheres, such as in a coated layer thereof, are disposed directly upon the substrate, and a microwave-interactive component, such as a coated layer of carbon or metallic particles, is disposed on the microspheres. The microspheres and the microwave-interactive component are in thermally conductive contact with each other because they are in contact with each other. Thermal conductivity could exist between the microspheres and the microwave-interactive component without direct physical contact between them, however (i.e. where another layer interposed therebetween), and, as noted above, the configuration shown in FIG. 1 could be reversed with the microwave-interactive component being interposed between the substrate and the microspheres.

An object to be heated may be disposed in heatable proximity to a microwave susceptor of this invention, in which spatial relation heat is transferred from the susceptor to the object to be heated. Upon being subjected to microwave irradiation, the microwave susceptor will undergo heating, which in turn will cause the heatable object to undergo heating, particularly at the surface thereof. The heatable object may be any non-electrically conductive material, which may or may not be transparent to microwave radiation. Thus, a heatable object may be heated both by the direct absorption of microwave radiation, and by the conductive heating of the microwave susceptor.

A further embodiment of this invention is thus a method of heating an object by placing the object in heatable proximity to a microwave susceptor of this invention, and exposing the object and the susceptor to microwave radiation. In a preferred embodiment, the object to be heated is a food item such as a pizza or raw pizza dough.

Of particular interest is the use of this invention to heat a food item placed in proximity to a susceptor hereof. The food item may be placed directly in contact with the susceptor, or may be placed in a separate container which is placed in contact with the susceptor. A food item of particular interest is a pizza, which requires excellent browning and crisping without charring. The food item, and a susceptor hereof, may be contained in a housing, enclosure or package for ease of storage, shipping and protection from contamination. Thus, according to a method of the invention, the combination of a food item disposed proximate to a susceptor hereof may be placed in a package for the purpose of being heated. The package may be provided with an opening to the interior during heating in order to allow venting of hot gases.

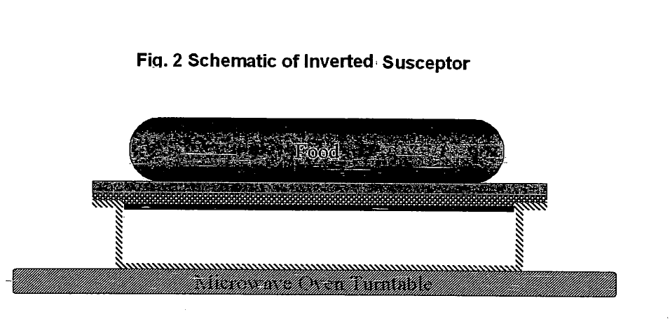

A further embodiment of this invention is thus an article comprising a combination of an object and a microwave susceptor of this invention, wherein the object is placed in heatable proximity to the susceptor. In a preferred embodiment, the object to be heated is a food item such as a pizza. FIG. 2 shows such a combination-type article.

In other embodiments, a microwave susceptor hereof may be incorporated into a layered structure. In addition to the susceptor, the layered structure may be fabricated from other layers made from materials for use as a substrate such as described above. The layered structure may be used to protect human food, such as a frozen pizza, from contamination.

In another embodiment, an article may be prepared by enclosing a microwave susceptor hereof in a package prepared from materials that are suitable for use to protect human food from contamination. In a further embodiment, an article may be fabricated in which a microwave susceptor hereof is contacted with a package prepared from materials that are suitable for use to protect human food from contamination. Such package may be fabricated from a material that is FDA approved and/or is not microwave interactive.

In a further embodiment, this invention also provides a method of making a microwave susceptor by fabricating the susceptor from a substrate, expandable microspheres and a microwave-interactive component. The method may further involve incorporating the susceptor into a layered structure. The layered structure may in turn be fabricated from substrate-type material that is not microwave interactive, and the layered structure may be fabricated into a package that protects human food from contamination. Alternatively, a susceptor as provided herein may be enclosed in, or contacted with, a package that protects human food from contamination.

In a further embodiment, this invention also provides method of heating an object by placing the object is heatable proximity to a microwave susceptor as provided herein, and subjecting the object and the microwave susceptor to microwave radiation.

The range of circumstances for which the susceptor of this invention, and articles prepared therefrom, are useful is further extended by additionally preparing compositions designed particularly for microwave ovens of varying power, which may vary, for example, within at least the range of about 700˜1200 Watts.

While the operability of the present invention does not depend upon any particular mechanistic explanation, it is believed that the heat expandable microspheres employed in the susceptor hereof are particularly useful at preventing the thermal runaway (uncontrolled rapid rise of temperature) of the susceptor. It is believed that, upon heating to the activation temperature (the temperature at which the volatilizable substance within the microspheres undergoes volatilization), the microspheres expand (which may be up to about a 40-fold volume expansion), physically disrupt the microwave-interactive component, and thereby reduce the rate of heating of the whole susceptor. Thus, in a preferred embodiment, a temperature plateau is achieved wherein cooking proceeds within a relatively narrowly maintained temperature range.

For example, FIG. 8 of Morehouse is a schematic cross-sectional view of a substrate having on one surface thereof a coating comprising a semi-crystalline thermoplastic resinous binder having contained therein a plurality of expandable particles having encapsulated therein a liquid-volatilizable compound. Upon thermal activation, the volatilizable compound volatilizes causing a rapid rise in internal pressure, causing the expandable particles to swell, resulting in the morphology shown in FIG. 9 of Morehouse.

The present invention is further described in the following specific embodiments, which are illustrative but not limiting.

### EXAMPLES

A carbon black ink concentrate was prepared in three steps. First, a carbon black concentrate was prepared as follows: Surfactant, water and defoamer were mixed together with a Cowles blade at 1800 rpm for 10 minutes at room temperature. Carbon black pearls were added all at once while under agitation and allowed to mix for 30 minutes. The mixture was then milled in 2 passes through a sand mill.

A portion of the ink concentrate and water were mixed in a one liter vessel with a Cowles blade at 500 rpm for 10 minutes at room temperature. Soy protein was then added to the thus formed carbon black dispersion, and the pH of the resulting mixture was adjusted to 10 by adding ammonium hydroxide. This pH-adjusted mixture was mixed with the Cowles blade at 1500 rpm for one hour. The speed was then reduced to 500 rpm and glycerin and biocide were added and mixed for 10 minutes. The components of the intermediate ink were: Carbon black 12.5 wt % (Cabot Black Pearls 4350), dispersing aid 5.0 wt % (Tween 80), soy protein 12.5 wt % (DuPont Procote 5000), NH3 2.1 wt %, Glycerin 1.0 wt %, defoamer 0.5 wt % (Foamblast EPD), biocide 0.2 wt % (Proxel GXL), and water 66.2 wt %. The pH of this ink was 10.

### Example 1

3 grams of Expancels™ (98DU120) microspheres were added to 28 grams of the ink composition so formed.

A 30 cm×30 cm×0.1 mm sheet of DuPont Type 4.0N710 aramid paper was coated with a base coat using a #12 draw-down rod (Standard Lab Metering Rod from Paul N. Gardner Company). The composition of the base coat was 14.7 wt % soy protein polymer(Pro-cote 200 from Bunge), 1.1 wt % glycerin, 0.74 wt % ammonia, and 83.46 wt % distilled water. The thus coated sheets were dried in an 100° C. oven for 15 minutes. The Expancel™-containing ink formulation prepared as described herein above was applied to the thus dried base-coated aramid paper using a #12 draw-down blade. The thus coated sheet was dried in a 100 degree C. oven (VWR's Utility Oven Model 1305U) for 20 minutes and then allowed to cool.

A 2″×2″ (5.1 cm×5.1 cm) specimen was cut from the thus prepared 30 cm square sheet. The thus prepared microwave susceptor specimen was exposed to 150 Watts of microwave power at 2450 MHz in a microwave wave-guide instrumented with an Iris infrared (IR) thermometer equipped with a non-contacting infrared temperature probe. The microwave power was started at 50 Watts and then monotonically increased to 150 Watts at the rate of 1 W/sec.

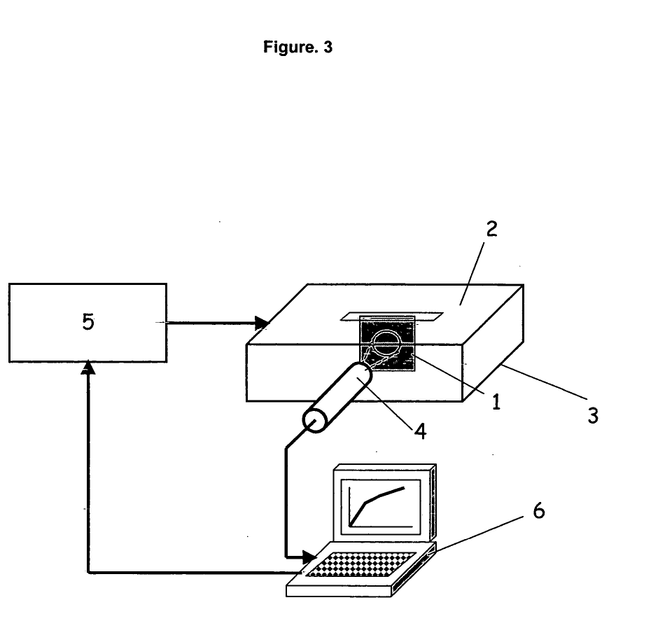

FIG. 3 shows a block diagram of the testing instrument. The 2″×2″ test specimen, 1, was placed in a rectangular waveguide, 2, supporting a TE10 standing wave mode at 2450 MHz. In the TE10 mode, the vertical electric field is maximum at the middle of the long side of the cross section, 3 and the test specimen positioned at this maximum. An infrared thermometer, 4, was placed on the short wall pointing at the test specimen. The microwave energy source was a magnetron [Astex 1500A], 5, oscillating at 2450 MHz with a capability for a continuously variable power output in the range of 50 to 1500 W. The magnetron power output was controlled by a computer, 6. Power was increased step wise, at a rate of 1 W/sec. The accompanying rise in temperature of the test sample was determined by the infrared thermometer.

The IR thermometer used to measure the change in temperature of the test samples in the analytical instrument described above gave very precise readings, but the accuracy of its readings, in terms of comparing the change in temperature of one susceptor to another, can be affected by the fact that an infrared thermometer is calibrated to read the temperature of a black body. The thin, coated films used as the samples herein deviated from an ideal black body, and different types of susceptors may also differ in reflectance such that exposure to a particular dose of microwave radiation can result in different degrees of heating. The readings given by the IR thermometer were thus interpreted in view of those factors.

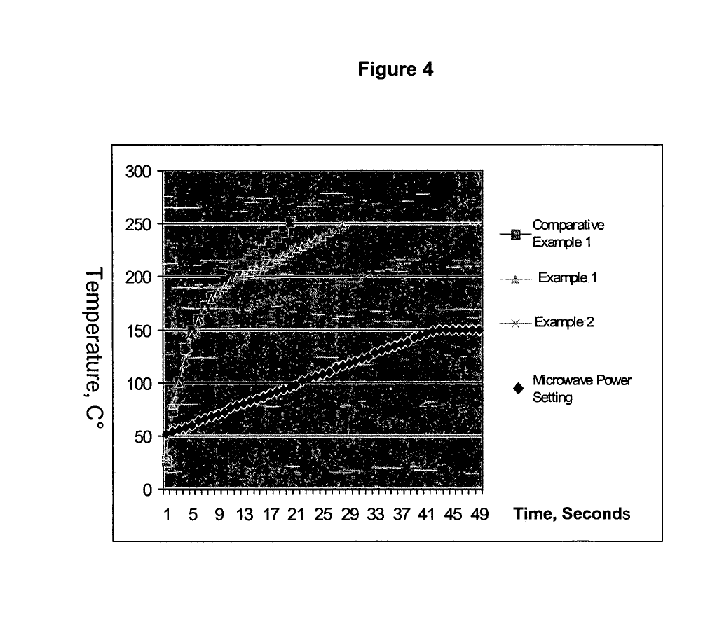

FIG. 4 shows the temperature of the test specimen for Example 1 versus time of exposure to the microwave radiation. The test specimen exhibited a decrease in heating rate at a temperature of about 175° C. after about 10 seconds of exposure to an increasing microwave power.

### Example 2

The methods and materials of Example 1 were repeated except that 20 wt-% of the Expancel™ microspheres were added to the master batch (for a 30 cm×30 cm sheet, 6 grams of Expancel™ microspheres were added to 28 grams of carbon back ink). Microwave heating results are also shown in FIG. 4. The specimen for Example 2 underwent a sharp decrease in the rate of heating at about 160° C. after about 8 seconds of exposure to increasing microwave radiation.

### Comparative Example 1

The materials and procedures of Example 1 were employed except that no Expancel™ microspheres were incorporated into the ink composition sample. Results are shown in FIG. 4. The specimen for Comparative Example 1 appears to exhibit a small reduction in heating rate at ca. 190° C.

### Examples 3-5 and Comparative Example 2

In these examples, a separate coating layer containing the heat expandable Expancel® 98DU120 microspheres was first coated onto the 30 cm×30 cm×0.1 mm aramid substrate followed by a coating of an aliquot of the ink composition not containing any of the Expancel™ microspheres, thereby forming essentially the microwave susceptor structure of FIG. 1. The first coating layer consisted of the Expancel® 98DU120 heat expandable microspheres and soy protein polymer (Solae® Procote 2500) as the binder.

The microwave susceptor specimens of Comparative Example 2 and Examples 3, 4 and 5 had a precoat layer that contained varying amounts of the Expancel 98DU120 microspheres in the composition of the precoat. Comparative Example 2 and Examples 3, 4 and 5 had 0, 10, 20 and 30% by weight of the microspheres in the precoat composition, respectively.

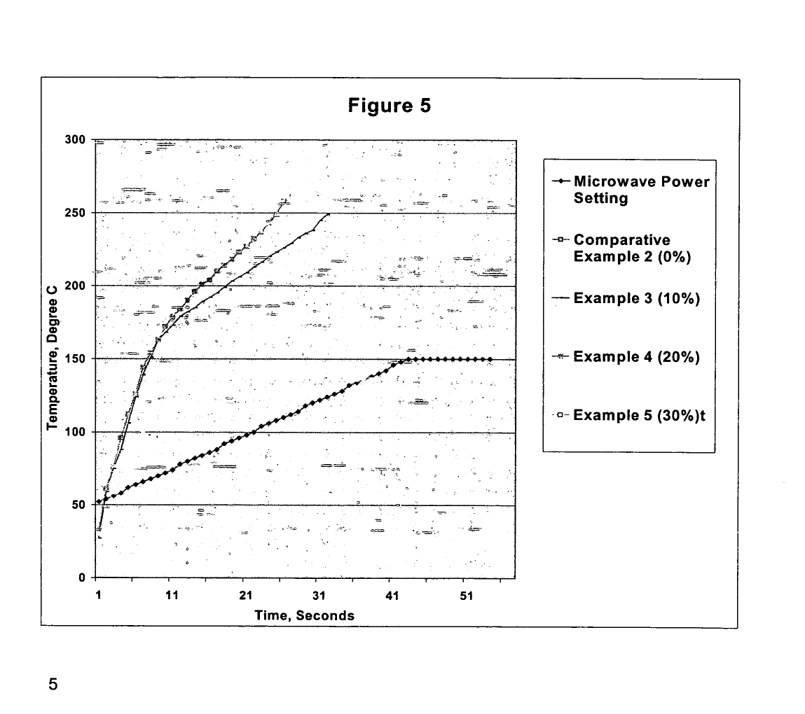

FIG. 5 shows the temperature versus time of exposure of the thus prepared microwave susceptor specimens having a precoat as described above. In Comparative Example 2, a small reduction in heating rate was observed at about 160° C. after about 10 seconds of exposure to an increasing microwave intensity. The specimen of Example 3 showed a slightly sharper rate of heating decrease, but continued to heat rapidly. The specimen of Example 4 showed a much sharper decrease in heating rate with an onset of about 150° C. after about 11 seconds of exposure. Subsequent heating paralleled the rate of microwave radiative power increase, and the heating of the specimen plateaued when the microwave heating rate plateaued. The specimen of Example 5 showed a rapid heating stage up to about 135° C. and about 11 seconds of exposure, at which point the heating rate simply plateaued so that the temperature remained constant, even as the microwave radiation intensity increased.

### Example 6

7 g of Expancel™ 92DU80 microspheres were combined with 28 g Procote 2500 soy protein binder. Expancel™ 92DU80 microspheres have a nominal expansion activation temperature of 122-132° C. according to the manufacturer. The thus prepared mixture was applied to a 30 cm×30 cm×0.1 mm sheet of DuPont Type 4.0N710 aramid paper by use of a #12 draw-down rod. The resulting coated paper was heated at 100° C. for 15 minutes. The ink composition (without microspheres) was applied using a #12 draw-down rod. The resulting twice coated film was again dried at 100° C., this time for 20 minutes.

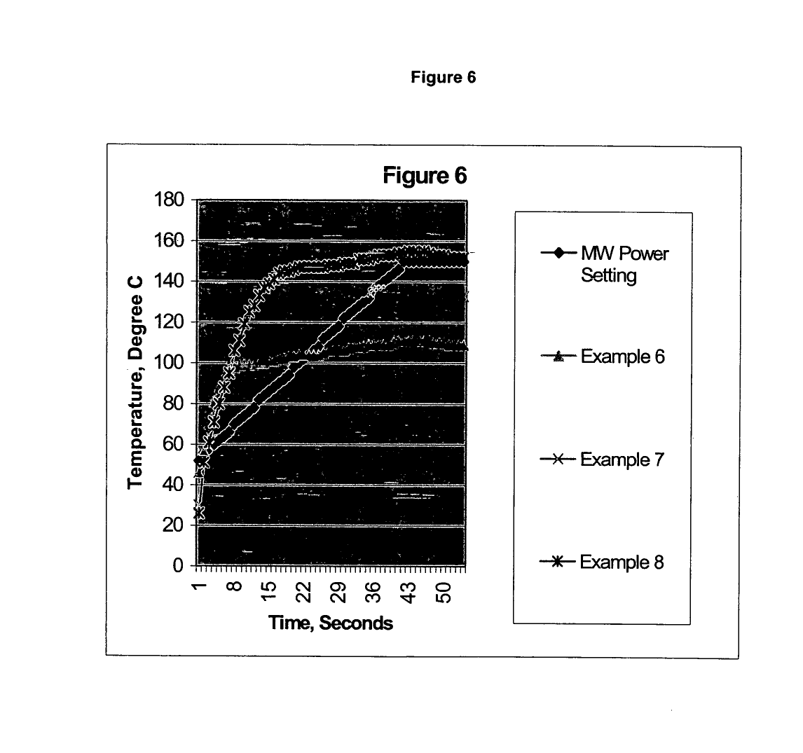

A 2″ square specimen was cut from the sheet and tested in the apparatus of FIG. 3 as described above. Results for heating vs. time are shown in FIG. 6. At about 95° C. and about 7 seconds of exposure, the specimen of Example 6 showed a plateau in temperature.

### Example 7

The materials and procedures of Example 6 were repeated except that Expancel™ 95DU120 microspheres were substituted for Exapancel™ 92DU80 microspheres. Expancel™ 95DU120 microspheres have a nominal expansion temperature of 135-145° C. Results for heating vs. time are shown in FIG. 6. At about 135° C. and after about 9 seconds of exposure, the specimen of Example 7 showed a sharp reduction in heating rate, with the temperature plateauing.

### Example 8

The materials and procedures of Example 6 were repeated except that Expancel™ 98DU120 microspheres were substituted for Exapancel™ 92DU80 microspheres. Expancel™ 98DU120 have a nominal expansion temperature of 155-170° C. Results for heating vs. time are shown in FIG. 6. At about 142° C. and after about 15 seconds of exposure, the specimen of Example 8 showed a substantial reduction in heating rate, with the temperature plateauing.

### Examples b 9˜11

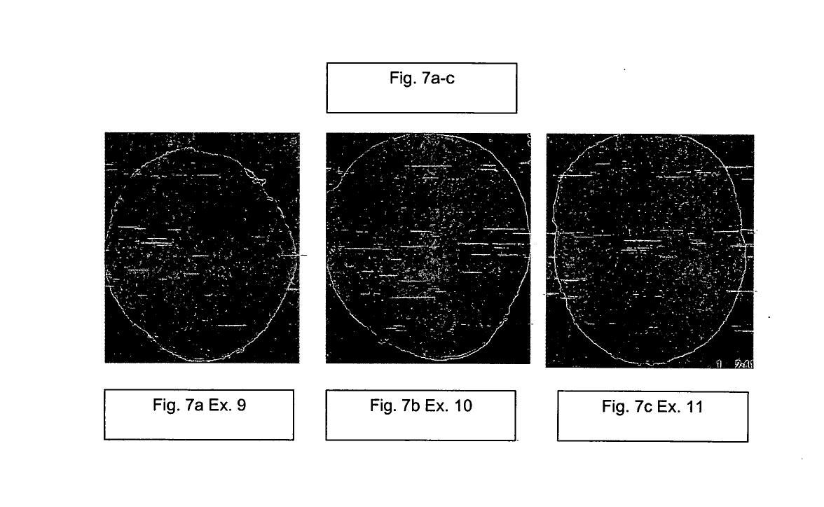

A circular specimen prepared from each of the microwave susceptors in Examples 6-8, as described above, was placed on a new, never-used inverted paper plate (microwave safe and grease resistant paper plate distributed by Supervalu Inc., Eden Prairie, Minn.) in a 1200 W microwave oven (Kenmore 1200). A frozen pizza (6.5 inch diameter Digiorno with Extra Cheese) was placed on the circular microwave susceptor with the susceptor ink side in contact with the paper plate (that is, face down away from the pizza). Cooking was performed for 5 minutes at 100% power in a microwave oven (Kenmore Model 1200 W). FIG. 7a-7c show the pizza crust browning results for the susceptors of Examples 9-11, which were prepared, respectively, from the samples of Examples 6-8. FIGS. 7a-7c show that there was browning but no charring or burning of the pizzas cooked in Examples 9-11.

Where a composition, article or method of this invention is stated or described as comprising, including, containing, having, being composed of or being constituted by certain components or features, it is to be understood, unless the statement or description explicitly provides to the contrary, that one or more components or features in addition to those explicitly stated or described may be present in the composition, article or method. In an alternative embodiment, however, the composition, article or method of this invention may be stated or described as consisting essentially of certain components or features, in which embodiment components or features that would materially alter the principle of operation or the distinguishing characteristics of the composition, article or method are not present therein. In a further alternative embodiment, the composition, article or method of this invention may be stated or described as consisting of certain components or features, in which embodiment components or features other than those stated or described are not present therein.

Where the indefinite article “a” or “an” is used with respect to a statement or description of the presence of a component or feature in a composition, article or method of this invention, it is to be understood, unless the statement or description explicitly provides to the contrary, that the use of such indefinite article does not limit the presence of the component or feature in the composition, article or method to one in number. The words “include”, “includes” and “including”, when used herein, are to be read and interpreted as if they were followed by the phrase “without limitation” if in fact that is not the case.

What is claimed is:

1. A microwave susceptor comprising a substrate, a microwave-interactive component that is supported by the substrate, and a plurality of expandable semicrystalline thermoplastic polymeric microspheres that are in thermally-conductive contact with the microwave-interactive component.

2. The microwave susceptor of claim 1 wherein the semicrystalline thermoplastic polymer from which the microspheres are made is selected from the group consisting of acrylate copolymers, poly(vinyl halide)s, poly(vinylidene halide)s, poly(vinyl ester)s, copolymers thereof, and mixtures thereof.

3. The microwave susceptor of claim 2 wherein the semicrystalline thermoplastic polymer is selected from the group consisting of copolymers of vinyl chloride and vinylidene chloride, copolymers of acrylonitrile with vinyl chloride or vinyl bromide, poly(vinyl acetate), poly(vinyl butyrate), poly(vinyl stearate), poly(vinyl laurate), poly(vinyl myristate), and poly(vinyl propionate), and mixtures thereof.

4. The microwave susceptor of claim 2 wherein the semicrystalline thermoplastic polymer is selected from the group consisting of poly(vinylidene chloride) and copolymers thereof with acrylonitrile, and poly(vinyl chloride), and mixtures thereof.

5. The microwave susceptor of claim 1 wherein the diameter of the expandable semi-crystalline thermoplastic polymeric microspheres is in the range of about 10 to about 100 micrometers.

6. The microwave susceptor of claim 1 wherein the microwave-interactive component comprises a film, or a conductive particulate material dispersed in a binder.

7. The microwave susceptor of claim 6 wherein the conductive particulate material is nano-scale carbon black.

8. The microwave susceptor of claim 6 wherein expandable semicrystalline thermoplastic polymeric microspheres are also dispersed in the binder.

9. The microwave susceptor of claim 6 wherein the binder is selected from the group consisting of acrylic polymers, protein polymers, shellacs, and maleic polymers.

10. The microwave susceptor of claim 6 wherein the binder comprises a protein polymer.

11. The microwave susceptor of claim 6 wherein the binder comprises a soy protein.

12. The microwave susceptor of claim 1 wherein the microwave-interactive component comprises 5 to 20 parts by weight protein polymer binder; 7 to 20 parts by weight of a substantially non-aggregated particulate, nonmetallic, nano-scale microwave-interactive material; 50 to 88 parts by weight of water; and, optionally, up to 10 parts by weight of a chemical dispersing aid.

13. The microwave susceptor of claim 1 which comprises (a) a first layer, disposed on the substrate, that comprises expandable semicrystalline thermoplastic polymeric microspheres and a binder; and (b) a second layer, disposed on the first layer, that comprises a microwave-interactive film, or microwave-interactive particulates; wherein the first layer is in thermally conductive contact with the second layer.

14. The microwave susceptor of claim 13 wherein the binder comprises a protein polymer.

15. The microwave susceptor of claim 14 wherein the protein polymer comprises a soy protein.

16. The microwave susceptor of claim 1 wherein the expandable semi-crystalline thermoplastic polymeric microspheres comprise a volatilizable compound contained therewithin.

17. The microwave susceptor of claim 16 wherein the volatilizable compound is selected from the C₃-C₈ alkanes.

18. The microwave susceptor of claim 1 wherein the substrate is an aramid paper.

19. The microwave susceptor of claim 1 which comprises a layer in a layered structure.

20. The microwave susceptor of claim 19 wherein the layered structure protects human food from contamination.

21. The microwave susceptor of claim 1 which is enclosed in or contacted with a package that protects human food from contamination.

22. A method of making a microwave susceptor comprising providing a substrate, supporting a microwave-interactive component on the substrate, and disposing expandable semicrystalline thermoplastic polymeric microspheres in thermally-conductive contact with the microwave-interactive component.

23. A method of making a microwave susceptor comprising providing a substrate, depositing expandable semicrystalline thermoplastic polymeric microspheres on the substrate, and disposing a microwave-interactive component on the microspheres.

24. A method of making a microwave susceptor, comprising (a) admixing expandable semicrystalline thermoplastic polymeric microspheres, microwave interactive particulates, and a binder; and (b) applying the mixture to a substrate.

25. The method of any one of claims 22-24 wherein the susceptor is fabricated as, or is contacted with, a package that protects human food from contamination.
